(19) United States
(12) Patent Application Publication
(10) Pub. No.: US 2023/0339568 A1
(43) Pub. Date: Oct. 26, 2023

(54) Dual-Energy Bicycle

(71) Applicant: Bertin Ayotte, Merrimack, NH (US)

(72) Inventor: Bertin Ayotte, Merrimack, NH (US)

(21) Appl. No.: 17/727,701

(22) Filed: Apr. 23, 2022

(51) Int. Cl. B62M 1/12; B62M 9/16; B62M 3/16; B62M 3/08

(52) U.S. Cl. CPC B62M 1/12; B62M 3/08; B62M 3/16; B62M 9/16

(57) ABSTRACT

The Dual-Energy Bicycle is the only product of its kind that can be altered to be used in three different and unique ways to train all regions of the body. In addition to these three operating modes, this unprecedented bike is uniquely designed with an adjustable primary seat, an adjustable chest support, and a greater front wheel angle. Furthermore, the Dual-Energy Bicycle is carefully crafted with durable materials to ensure long term sustainability and complete functionality based on consumer preferred use and/or based on the terrain being explored.

### BACKGROUND

Biking is a sport enjoyed by many, as a casual experience or as a reliable means of transportation, but for those who wish to simultaneously train their arms or upper bodies while biking to allow for a more diverse, personalized, and practical bike riding experience. There have been no products available as original equipment or as an aftermarket to address this problem.

An apparatus to allow individuals to simultaneously train their arms and upper body while biking. There have been no products available as original equipment or as an aftermarket to address this problem either.

There exists a need for a hybrid energy bicycle and apparatus that is not being met by any known or disclosed device or system of present.

### SUMMARY OF THE INVENTION

The main purpose of the Dual-Energy Bicycle is to provide users with a modern bike with three operating modes for transport. A Dual-Energy bicycle comprising a handle axis disposed in a steering column of the bicycle and a handle sprocket wheel configured to engage a handle chain. A plunger on a left side and on a right side of the handle axis are loaded with a spring to engage the plunger with the handle axis. A gear on the right side of the handle has 2 positions, A: push in to lock the handlebars in many locations chosen by the cyclist. B: pull out to use the handlebars to assist the foot pedals. The disclosure also enables hand pedaling by itself identified herein. Also, the spring loaded ball bearing maintains the gear in the intended position without sliding in or out.

Additionally, a left handle bar and a right handle bar are attached in a concentric rotational relation to the respective left side plunger and to the right side plunger, wherein the concentric rotation of one of the left handle bar and the right handle bar cause a proportional rotation of the handle axis and a pedal sprocket wheel via the handle chain there between. Furthermore, the left handlebar is equipped with a spring and is slotted to fit two positions on a cotter pin which can be parallel to or 180 degrees offset to the right handlebar.

### BRIEF DESCRIPTION OF THE DRAWINGS

FIG. 1 is a left-side elevational view of the Dual-Energy Bicycle in accordance with an embodiment of the present disclosure.

FIG. 2 is a right-side elevational view of the Dual-Energy Bicycle in accordance with an embodiment of the present disclosure.

FIG. 3 is a right-side elevational view of the Dual-Energy Bicycle in accordance with an embodiment of the present disclosure.

FIG. 4 is a right-side elevational view of the Dual-Energy Bicycle in accordance with an embodiment of the present disclosure.

FIG. 5 is a right-side elevational view of the Dual-Energy Bicycle in accordance with an embodiment of the present disclosure.

FIG. 6 is a view of the spring loaded ball bearing with adjustable tension between the front wheel fork and the front wheel fork housing in accordance with an embodiment of the present disclosure.

Throughout the description, similar reference numbers may be used to identify similar elements depicted in multiple embodiments. Although specific embodiments of the invention have been described and illustrated, the invention is not to be limited to the specific forms or arrangements of parts so described and illustrated. The scope of the invention is to be defined by the claims appended hereto and their equivalents.

### DETAILED DESCRIPTION

Reference will now be made to exemplary embodiments illustrated in the drawings and specific language will be used herein to describe the same. It will nevertheless be understood that no limitation of the scope of the disclosure is thereby intended. Alterations and further modifications of the inventive features illustrated herein and additional applications of the principles of the inventions as illustrated herein, which would occur to one skilled in the relevant art and having possession of this disclosure, are to be considered within the scope of the invention.

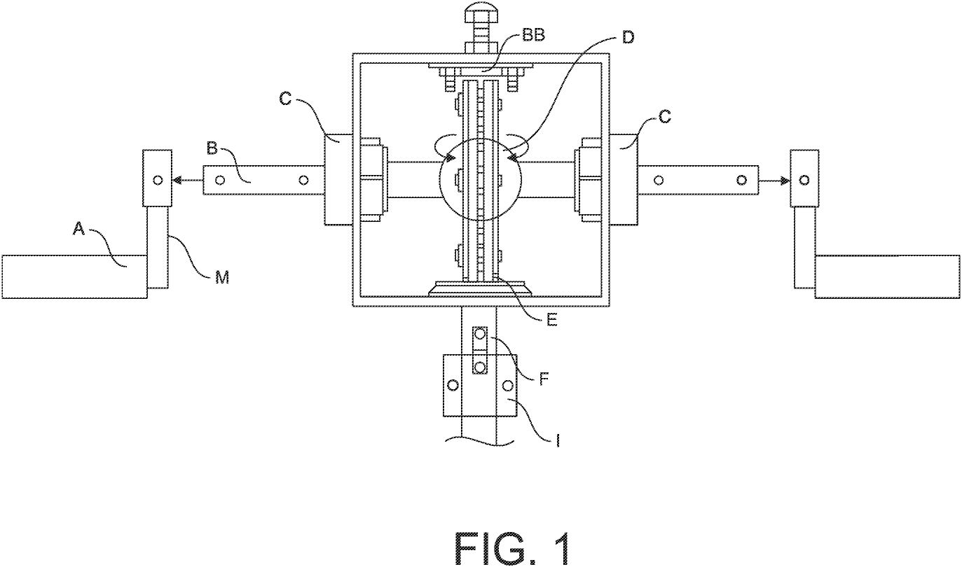

FIG. 1 is a left side elevational view of the Dual-Energy Bicycle showing: handle bars or also known as handle attachments referenced as A, spring loaded plunger can be pushed/flipped 180 degrees referenced as B, stationary gear referenced as C, ball joint for turning referenced as D, chain referenced as E, bike steering wheel pole referenced as F, assist straight pedaling stabilization referenced as I, and a spring loaded handle in accordance with an embodiment of the present disclosure. Two positions are available for locking gears in the housing to restrain or prevent movement outward and to assist foot pedaling or pedaling with arms only. A sprocket housing extends between two bearings to hold it straight while turning the handles of the bicycle. Ball bearings BB provide support to the ball joint D. The left side stationary gear “C” does not exist on some embodiments of the disclosed bicycle, only on the right side, but a manufacturing company may choose to install it either side, but only one is sufficient.

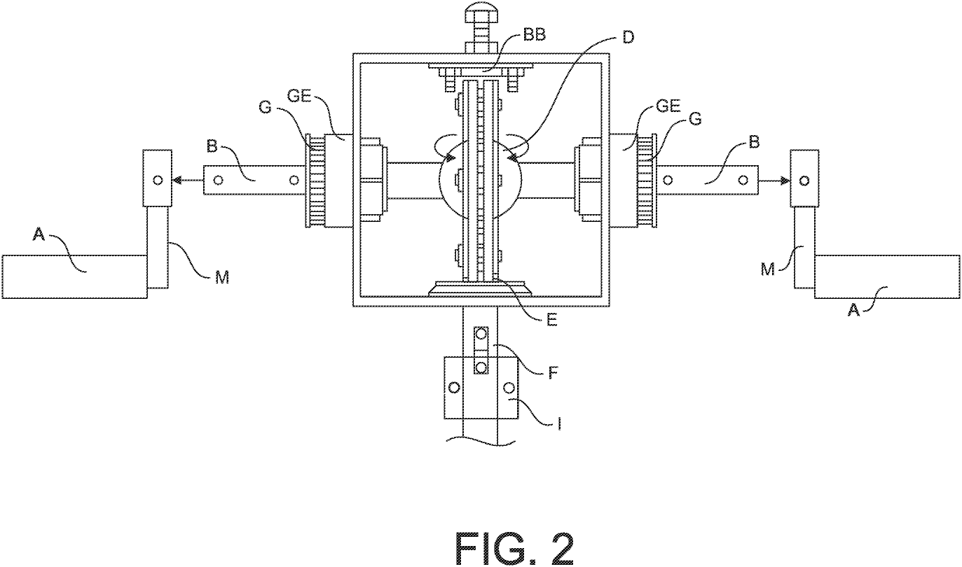

FIG. 2 is a right side elevational view of the Dual-Energy Bicycle showing: handle attachment referenced as A, spring loaded plunger can be pushed/flipped 180 degrees referenced as B, ball joint for turning referenced as D, chain referenced as E, bike steering wheel pole referenced as F, 2-position movable gear referenced as G, assist straight pedaling stabilator/stabilization referenced as I, in accordance with an embodiment of the present disclosure. The gear enclosure GE encloses gear G on a left side or a right side or both depending on design and engineering parameters in multiple embodiments. Other reference characters and limitations apply as depicted in other figures herein. The left side “G & GE” are not present in some embodiments of the disclosure, only on the right side is sufficient for the present embodiment.

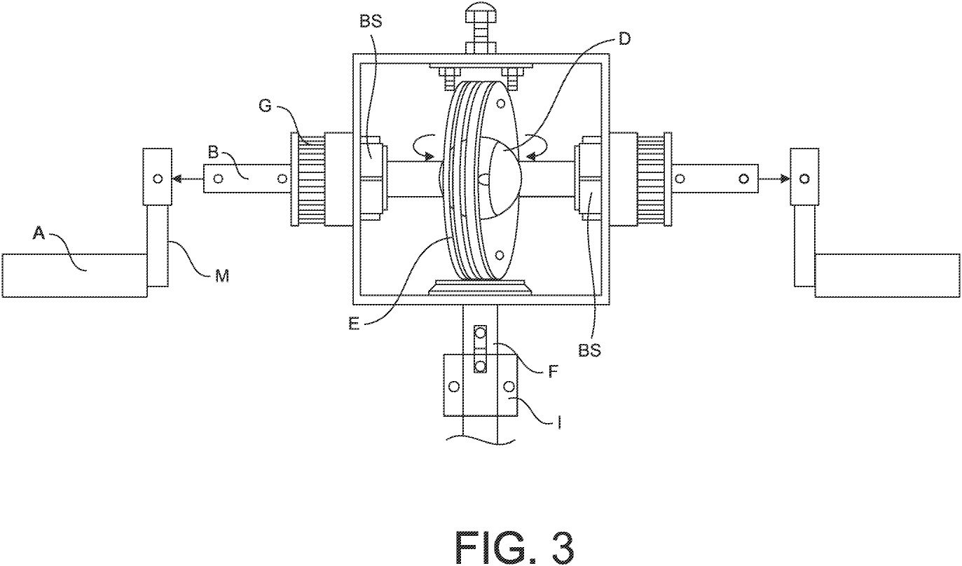

FIG. 3 is a right-side elevational view of the Dual-Energy Bicycle showing: handle bars or handle attachments referenced as A, ball joint for turning referenced as D, chain referenced as E, bike steering wheel pole referenced as F, assist straight pedaling stabilization referenced as I, in accordance with an embodiment of the present disclosure. Bushings BS on the right and left sides provide support to the gear box and the handle mechanisms. Other reference characters and limitations apply as depicted in other figures herein. The left side “G & BS” does not exist in some embodiments of the disclosure, only on the right side. Also, “E” does not move from side to side with the handle bar, but it maintains chain alignment by the two small bearings inside top of “GB”.

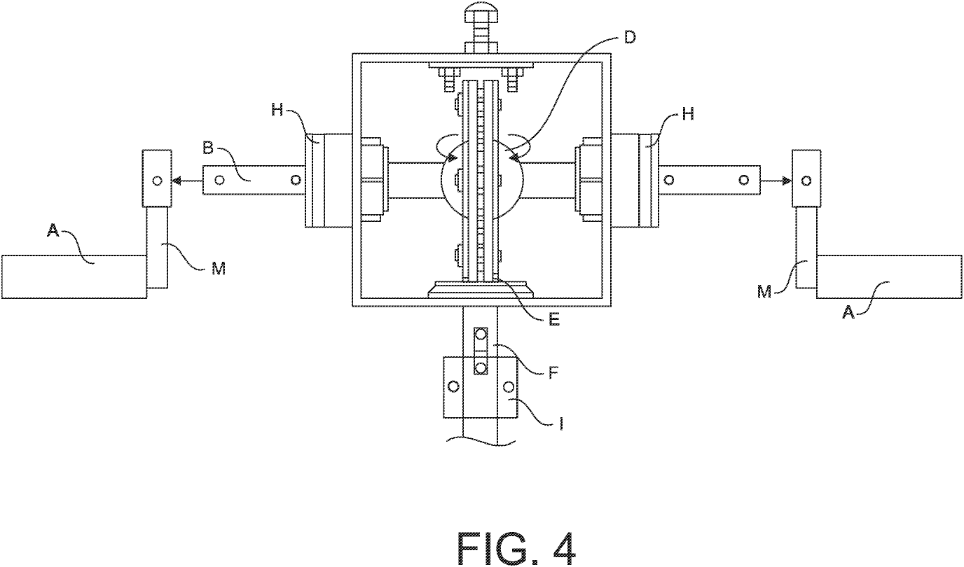

FIG. 4 is a right-side elevational view of the Dual-Energy Bicycle showing: handle attachment referenced as A, spring loaded plunger can be pushed/flipped 180 degrees referenced as B, ball joint for turning referenced as D, chain referenced as E, bike steering wheel pole referenced as F, locked mode referenced as H, assist straight pedaling stabilization referenced as I, in accordance with an embodiment of the present disclosure. A spring loaded ball bearing is torque adjustable and mates with a concave hole in the fork shaft of the same diameter as the ball bearing. Locked mode mechanism H enables a right side or a left side mechanism(s) according to embodiments herein. In the present embodiment, there is no left side “H” that may exist with other embodiments.

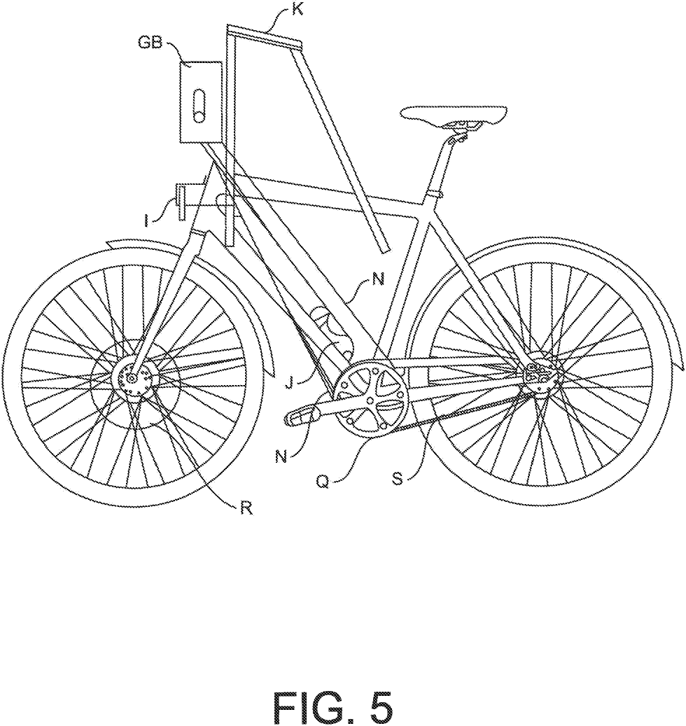

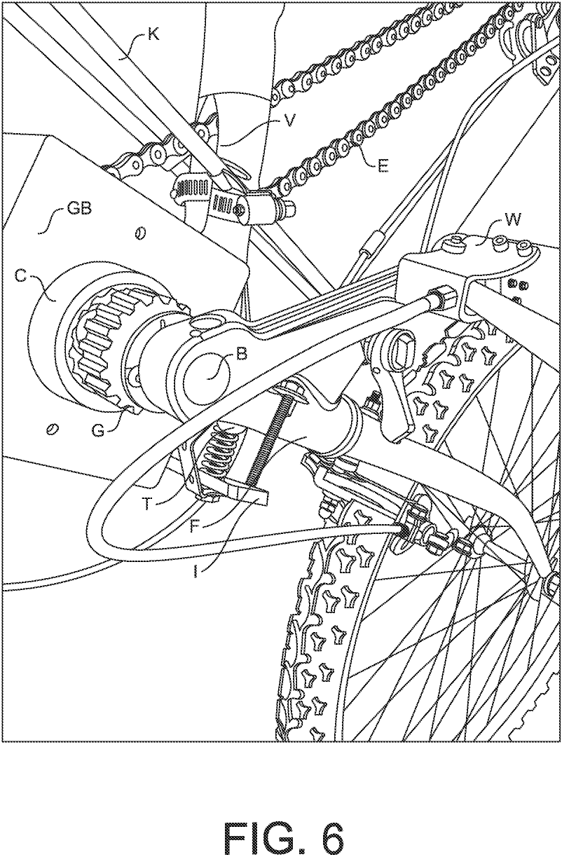

FIG. 5 is a right-side elevational view of the Dual-Energy Bicycle showing: assist straight pedaling stabilization referenced as I, idler referenced as J, chest support referenced as K, bike chain inside a removable tubing (to protect legs), in accordance with an embodiment of the present disclosure. A rotation arm extends the motion of the handlebars to the plunger and varies in length according to manufacturing parameters for a torque transfer from the handlebars to the handle chain and front wheel sprocket wheel as explained herein. A dedicated pedal sprocket wheel Q is configured to receive the handle chain and drive a common pedal axis with a pedal chain S of the bicycle. The gear box GB houses components of the disclosure. A dedicated sprocket with the same diameter and number of teeth as the sprocket in the gear box GB is positioned in the center of the foot pedal shaft similar to Q in FIGS. 5 and 6. In the present embodiment, “GB” has a center hole only and is not slotted.

In some embodiments of the disclosure, “L” is not implemented as part of the disclosed bicycle. The disclosure has been rider tested via various methods and operators. The average time gain using both hands & feet is 13% for a distance of ¼ mile.

Expanding on the initial design of an average bicycle, the Dual-Energy Bicycle introduces a novel bike with special mechanisms and features that allow individuals to pedal with either their feet, with just their hands, or to pedal using their feet and hands, simultaneously. To operate the bicycle, the user simply locks the handles in the designated location to either use their hands, feet or both to navigate the bike. Most bike handles can only be locked in one location, whereas the Dual Energy Bicycle has multiple places the handles may be locked. The chest rest and seat are also adjustable. Furthermore, the Dual-Energy Bicycle is strategically designed with wide range wheel angles to allow for seamless maneuverability and provide extra mobility during transport which may help speed-up distance covered as movement is generated by combined physical efforts.

The main purpose of the DUAL-ENERGY BICYCLE is to provide the user with 3 modes of transportation. Feet pedaling only, arms pedaling only and feet and arms pedaling simultaneously. This bicycle is equipped with a steering column which has a gearbox attached to the front wheel fork column. Inside and through the gearbox is a shaft to which are 2 hand pedals are attached at each outside extremity thereof.

The right hand handlebar has a spring that pushes the handlebar outward. Close to the end of the shaft is inserted a cotter pin protruding from the shaft on each side so as to engage the handlebar. The handlebar is slotted to accept the cotter pin. The slot is deep enough as to permit the outside of the handlebar to be flush with the end of the shaft. Therefore the right handlebar can be pushed inward and flipped 180 degrees making it possible to be parallel to the left handlebar or 180 degrees offset.

The left hand handlebar is equipped with a 2 positions gear: engaged or locked. It is being held in one of the 2 specific locations by a single spring loaded ball bearing to prevent the gear from sliding in or out by vibration. The spring loaded ball bearing protrudes at the left or at the right of the gear maintaining it in its intended position.

When the two position gear is in the out position, it allows both handles to move. The cyclist can use it to help the feet pedals simultaneously or pedal with their hands only. The foot pedals do not need to move and can remain stationary while hand pedaling. When in the ‘in’ position meaning pushed into the gear housing which is bolted to the gear box, the hand pedals are locked in place and cannot move. In this specific embodiment, we have 18 different positions which the handles can be locked throughout the circumference of the handlebars.

The handlebars common shaft is being held inside the gearbox by 2 double bushings attached on each side of the gearbox. The handlebars common shaft has a fixed slotted ball bearing attached to the common shaft and centered inside the gearbox. The 2 slots on that ball bearing accept 2 pins coming out of the sprocket housing. Those 2 pins engage the ball bearing and make the sprocket turn. This ball bearing has 2 slots from left to right and are 180 degrees apart. The slots are there to permit the handlebar to move the front wheel left and right without interfering the alignment of the chain and sprocket.

Inside the top of the gearbox are 2 small pivoting bearings attached to the gearbox top so as to maintain the sprocket housing constantly aligned with the chain regardless of the movement of the front wheel.

The chain is running through the center of the bicycle frame to a fixed spring loaded idler. The idler is located at the return part of the chain in reference to the handlebars sprocket and keep a steady tension to eliminate the slack in the chain. The chain goes through the foot pedal frame to a fixed sprocket identical to the handlebar sprocket. That sprocket is exactly aligned with the center of the bicycle frame and the handlebar sprocket.

FIG. 6 is a view of the spring loaded ball bearing with adjustable tension between the front wheel fork and the front wheel fork housing in accordance with an embodiment of the present disclosure. A front of the bicycle includes an assist straight pedaling stabilization structure referenced as I, spring loaded ball bearing T that goes into a hole in the front wheel housing and mates with a concave match on the front wheel fork shaft. The hole in that shaft is not deep but has the same diameter as the ball bearing. The spring loaded ball bearing T is torque adjustable. The purpose of that mechanism is to help stabilize the front wheel while hand pedaling. The bicycle have an adjustable seat. It also has an adjustable chest rest to help the cyclist maintain stability while hand pedaling. A compression of the spring is set by adjusting a bracket of the structure mounted to a front of the bicycle distal the front wheel housing and proximal the front wheel housing to give the stability to the front wheel fork moving inside the front wheel housing. The bicycle frame defines an opening V for the chain E to go there through and turn the foot pedal sprocket. The attachment W secures the front wheel braking cable to the respective handlebars. The gear box GB houses the gearing for the disclosure.

Although the operations of the method(s) herein are shown and described in a particular order, the order of the operations of each method may be altered so that certain operations may be performed in an inverse order or so that certain operations may be performed, at least in part, concurrently with other operations. In another embodiment, instructions or sub-operations of distinct operations may be implemented in an intermittent and/or alternating manner.

What is claimed is:

1. A Dual-Energy bicycle comprising:
a handle axis disposed in a steering column of the bicycle and comprising a handle sprocket wheel configured to engage a handle chain;
a plunger on a left side and on a right side of the handle axis wherein a loaded spring of the plunger engages the plunger with the handle axis; and
a left handle bar and a right handle bar attached in a concentric rotational relation to the respective left side plunger and to the right side plunger,
wherein the concentric rotation of one of the left handle bar and the right handle bar cause a proportional rotation of the handle axis and a pedal sprocket wheel via the handle chain there between.

2. The dual-energy bicycle of claim 1, further comprising an idler bearing disposed between the handle sprocket wheel and the handle axis and configured to take up a slack in the handle chain.

3. The dual-energy bicycle of claim 1, further comprising a rotation arm disposed between the left and right plunger and the respective handle bar.

4. The dual-energy bicycle of claim 1, further comprising an A-frame chest support collar attached to a frame of the bicycle in a stationary relation thereto.

5. The dual-energy bicycle of claim 1, further comprising a dedicated pedal sprocket wheel configured to receive the handle chain and drive a common pedal axis with a pedal chain of the bicycle.

6. The dual-energy bicycle of claim 1, further comprising a tubing configured to encase the handle chain between the gearbox and the pedal sprocket wheel.

7. The dual-energy bicycle of claim 1, wherein the plunger engages the handle with the handle axis via a complementary gearing there between.

8. The dual-energy bicycle of claim 1, further comprising a locking relation between the handle axis and the steering column.

9. The dual-energy bicycle of claim 1, further comprising a handle axis extension.

10. The dual-energy bicycle of claim 1, wherein the rotation of the left handlebar and the right handlebar transfer a torque from a first sprocket wheel to a second sprocket wheel via the handle chain.

11. The dual-energy bicycle of claim 1, wherein the left handle bar and the right handlebar are attached in an adjustable concentric relation of 180 degrees out of phase relative to each other.

12. The dual-energy bicycle of claim 1, wherein the left handle bar and the right handlebar are attached in an adjustable concentric relation in phase relative to each other having 0 degrees and 360 degrees relation thereto.

13. The dual-energy bicycle of claim 1, wherein the left handlebar and the right handlebar are attached in an adjustable concentric relation in 18 out of phase positions relative to each other.

14. The dual-energy bicycle of claim 1, further comprising a support frame for the bicycle configured to define a slot there through to receive a passage of the handle chain there through.

15. The dual-energy bicycle of claim 1, further comprising an idler gear configured to allow the handle chain to be stationary with a rotational movement of the handle axis.

16. The dual-energy bicycle of claim 1, further comprising two small pivoting bearings attached to the handle axis so as to maintain the handle sprocket wheel constantly aligned with the handle chain regardless of a rotation of a front wheel.

17. The dual-energy bicycle of claim 1, further comprising an adjustable spring loaded ball bearing disposed between a front wheel fork and a front wheel housing of the front wheel fork configured to add stability to the front wheel fork movement therein.
